(19) United States
(12) Patent Application Publication
(10) Pub. No.: US 2017/0311638 A1
(43) Pub. Date: Nov. 2, 2017

(54) COMPOSITIONS AND PROCESSES FOR PRODUCING YOGURT-LIKE FOODSTUFFS WITHOUT USE OF DAIRY PRODUCTS

(71) Applicant: Ruby's Naturals, Inc., New York, NY (US)

(72) Inventors: Andrea McGregor, New York, NY (US); Stephen Davis, North Kingstown, RI (US)

(21) Appl. No.: 15/239,169

(22) Filed: Aug. 17, 2016

Related U.S. Application Data
(60) Provisional application No. 62/329,477, filed on Apr. 29, 2016.

(51) Int. Cl. A23L 19/00; A23L 29/231; A23L 27/00; A23L 33/105; A23L 33/185; A23L 29/238

(52) U.S. Cl. CPC A23L 19/09; A23L 33/185; A23L 29/238; A23L 27/00; A23L 33/105; A23L 29/231; A23V 2002/00

(57) ABSTRACT

A formula and process for producing a yogurt-like experience in a non-dairy alternative foodstuff. The non-dairy yogurt alternative provides significant servings of fruits and vegetables in a format that is free from nuts or soy. The formula and process of the present disclosure yield a shelf-stable, freeze-thaw stable, ready to eat non-dairy yogurt alternative foodstuff.

### FIELD OF THE INVENTION

The present disclosure relates to foodstuff compositions, a process for their manufacture, and products containing the same. More particularly the present disclosure relates to compositions and processes for producing yogurt-like foodstuffs without use of dairy products.

The present disclosure, by way of example only, will be described with reference to processing of foodstuffs to simulate yogurt, but it will be appreciated that the present disclosure is not necessarily so restricted and the novel approaches described herein can be more widely applicable. The foodstuff can be processed in other forms as a product that mimics the texture, flavor and consistency of traditional, dairy-based products other than yogurt.

### BACKGROUND OF THE INVENTION

Yogurt and other dairy products can supply certain desirable nutrients, but typically do not provide significant fruit and vegetable servings. In addition, yogurt and other dairy based products typically need constant refrigeration in order to prevent spoilage. Many consumers, especially children, may have food allergies, aversions to dairy products, or may want to limit their dairy intake for various reasons. For example, people may suffer from lactose intolerance. An aqueous dispersion of powdered nuts, especially almond powder, has been used to form a non-dairy milk alternative. However, some people may exhibit allergies to nuts and nut products. Food products containing soy are also well known, and many foods incorporate soy as an alternative to dairy. However, some people may avoid consuming soy for various health concerns. Accordingly, there is a need for non-dairy foods that possess tastes and consistencies similar to traditional dairy-based foods, but which will appeal to those individuals who may not be willing or able to eat soy or nut-based foodstuffs.

### SUMMARY OF THE INVENTION

The present disclosure provides a foodstuff formulation and methods of making it that creates a yogurt-like experience in a non-dairy format, without the use of nuts or soy, while delivering significant servings (for example 35-50% by weight of the total weight of the serving) of fruits and/or vegetables. Furthermore, unlike yogurt, the foodstuffs of the present disclosure can be fortified with protein and vitamins. In one embodiment, for example, foodstuffs of the invention can be fortified with up to 2 g/serving of protein and may provide up to 80% of the daily intake of vitamin C. Additionally, the non-dairy foodstuffs of the invention do not require refrigeration to prevent spoilage. The formula and process of the invention thus yield a shelf-stable, freeze-thaw stable, ready to eat non-dairy yogurt alternative.

In one embodiment, the present invention provides a process for making a non-dairy foodstuff. The process can comprise adding protein ingredient to heated water in a vessel and hydrating under shear to create a first mix; adding texturing ingredient selected from pectins, gums, tapioca, and combinations thereof to the first mix in the vessel and mixing to form a second mix; adding coconut ingredient to the second mix and mixing to form a third mix; adding at least one of a fruit ingredient, or a vegetable ingredient, each in the form selected from puree, juice, semi-solids, or combinations thereof, and citric acid ingredient to form a final mix; and mixing the final mix until all ingredients are fully incorporated to form the foodstuff. Optional embodiments of the process can also include steps for mixing in additional ingredients such as flavorants or colorants, cooling, homogenizing, pasteurizing, or packaging.

Another aspect of the present disclosure includes a formulation for a non-dairy foodstuff with the texture and mouthfeel of a dairy product comprising 20-70 wt. % of fruit ingredient or vegetable ingredient, or a combination thereof, 1-4 wt. % of protein ingredient, 2-8 wt. % of coconut ingredient, 2-8 wt. % of texturing ingredient, and 20-60 wt. % of water. Optional embodiments of the formulation can include 0.5-4 wt. % of flavoring ingredient, and up to 4 wt. % of optional ingredients such as colorings, stabilizers, or fortifiers.

### BRIEF DESCRIPTION OF THE DRAWING

FIG. 1 is a flowchart illustrating an exemplary process of making a foodstuff of the present invention.

### DETAILED DESCRIPTION OF THE INVENTION

The present disclosure relates to a non-dairy foodstuff which has properties, such as taste and mouth feel, similar to dairy products, especially yogurt. A foodstuff of the present invention may include fruit and/or vegetable, protein, coconut fat, texturing, and flavoring ingredients which are mixed in a shearing process. The present disclosure provides a novel combination of fruit(s) and/or vegetable(s) and protein into a yogurt-like product, closely approximating the experience of eating yogurt. The novel inclusion of coconut as a fat source desirably delivers the creamy texture of dairy products to the present non-dairy foodstuff, much like milk fat in yogurt. In some embodiments, foodstuffs of the disclosure may provide advantages such as: providing an alternative non-dairy foodstuff to yogurt or other milk or milkfat based products, providing a foodstuff with added vegetable nutrients (in addition to nutrients derived from fruit(s)), providing a yogurt-like product with added protein (such as a protein derived from peas), and providing a non-dairy yogurt-like product that does not need refrigeration.

The composition of the present disclosure may include fruit and/or vegetable, protein, coconut fat, texturing, and flavoring ingredients. Each ingredient is present to create a stable product with a thick yogurt-like texture. An important consideration when producing a non-dairy yogurt alternative (or any other dairy-like product) is how much the texture will be affected by the composition of ingredients. The resultant texture is dependent on the proportion of thicker viscosity ingredients to those of lower viscosities, and varies with the composition. Any proportion of the ingredients can be used which achieves a desirable texture similar to yogurt. For purposes of this disclosure, all percentages are given in weight percent (wt. %) of the total weight of the ingredients in the composition, unless otherwise stated. The weight percentage ranges given below are illustrative and not limiting, but have been found to result in the desirable texture of yogurt.

The fruit ingredient can be any suitable fruit or fruit-based product, such as, without being limited to, strawberry, pear, banana, blueberry, blackberry, pineapple, apple, apricot, coconut, grape, lemon, lime, melon, orange, peach, raspberry, acai, mango, passion fruit, papaya, plum or any combinations thereof. The fruit ingredient can be in the form of puree, juice, semi-solids, or combinations thereof that lend themselves to the mixing process. It has been found that fruit ingredient(s) can be included at 15-40 wt. %.

The vegetable ingredient can be any suitable vegetable or vegetable product such as, without being limited to, sweet potato, red beet, potato, carrot, squash, tomato, celery, pumpkin, kale, mustard, Swiss chard, spinach, broccoli, cauliflower, peas, beans, garlic, onion, radish, seaweed, and any combinations thereof. The vegetable ingredient can be in the form of a conglomeration of discrete solid, macroscopic particles such as granules or powder, puree, juice, or any combination thereof. It has been found that vegetable ingredient(s) can be included at 5-30 wt. %.

In some embodiments at least one of a fruit ingredient, a vegetable ingredient, or any combination thereof, can be present at 20-70 wt. %. The combination can be all fruit ingredient, all vegetable ingredient, or any combination thereof.

The protein ingredient can be from any suitable protein source. In some embodiments, the protein ingredient can comprise gluten-free vegetable protein and/or soy-free vegetable protein. Suitable gluten-free and soy-free vegetable proteins include pea protein and chia seed flour. It has been found that protein ingredient(s) can be included at 1-4 wt. %

In some embodiments, a coconut ingredient in the form of coconut fat is present in formulations of the invention. In some embodiments the coconut ingredient is coconut fat in the form of creamy coconut paste. The creamy coconut paste can be formed by heating dehydrated, finely ground coconut meat (sometimes called creamed coconut) until it is in a liquid state (to about 110-120° F.) and thoroughly mixing it under shear until it is creamy. As used herein, “creamy coconut paste” is defined as coconut fat that is liquefied and creamed under shear. The use of coconut fat, for example in the form of creamy coconut paste, in the foodstuff formulations of the invention can create a creamy texture similar to that of milk fat products (e.g., yogurt), while allowing the foodstuff to be dairy-free. Suitable sources of coconut fat, for example in the form of creamed coconut, are available from Global Organics Ltd, Cambridge, Mass. as Organic Coconut Cream Concentrate, part number 30028; and Brothers International Food Corporation, Rochester, N.Y. as Organic Creamed Coconut. It has been found that coconut ingredient can be included at 2-8 wt. %.

The texturing ingredient can be combined with the fruit ingredient and/or vegetable ingredient, protein ingredient, coconut ingredient, and flavoring ingredient to give the foodstuff the appropriate mouth feel similar to yogurt, or other dairy-based products. Texturing ingredients found to be useful for the present foodstuffs include various pectins, gums such as locust bean gum, tapioca or tapioca starch, glycerin, and any combination thereof. It has been found that the texturing ingredient(s) can be included at 2-8 wt. %.

The flavoring ingredient can be any natural or artificial flavoring such as, without being limited to, fruit, vegetable, chocolate, spice, herb, vanilla and any combinations thereof. Flavoring for use in the present foodstuff formulations is typically in the form of a liquid in order to maintain the ideal texture. In one embodiment, the flavoring ingredient comprises a citric acid slurry formed from a combination of citric acid, water and monkfruit extract that is mixed until the citric acid is dissolved. Citric acid slurry can be included at 1-2 wt. %. In some embodiments the amount of citric acid in the slurry can be selected to adjust the pH of the foodstuff. For instance, in embodiments wherein the fruit ingredient comprises a high-acid fruit such as lemon or lime, the amount of citric acid added can be adjusted to achieve a target pH, or pH range. In other embodiments, citric acid can be added in a dry form or as an aqueous solution. In some embodiments, monkfruit extract (or other suitable naturally occurring sweeteners) can also act as a low (or zero) calorie sweetener, to produce a low-sugar product. Low sugar levels can be maintained in the present foodstuff formulations, for example, by using other naturally occurring sweeteners in low proportions to the overall weight of the formulation. It has been found that flavoring ingredient(s) can be included at 0.5-4 wt. %.

Optionally, various ingredients known to the foodstuff industry, such as colorings and stabilizers, can be added. The foodstuff of the present invention can also optionally be fortified to increase its nutritional content, for example by addition of various proteins in addition to the vegetable or fruit protein already present, fiber, vitamins (such as Vitamin C) and/or other nutrients, for example minerals such as calcium or magnesium. In some embodiments, chia seed flour can be added to provide a source of fiber as well as protein. The optional ingredients can be included at 0-4 wt. %.

All ingredients in the formula are balanced to work with one another to create the resulting texture and flavor while yielding a nutritional foodstuff. Yogurt gets a smooth rich mouthfeel from milkfat when made with whole milk. When made from skim milk, the mouthfeel is less luxurious. Mouthfeel comes from gelled protein, as well as any fat content. The creamed coconut ingredient of the present foodstuff is a component of mouthfeel, as it provides a “richer” foodstuff. Pectins, gums, starches, and glycerin can also be components of mouthfeel. Suitable techniques to measure texture and mouthfeel of the present foodstuffs are known to those of skill in the art, and include using standard instruments known in the industry to characterize texture, such as viscometers or texture analyzers. Other suitable techniques to measure texture and mouthfeel of the present foodstuffs include mouthfeel assessments made subjectively by one or more people and compared, for example, to a control target assigned a rating according to a rating scale.

The process of forming a foodstuff of the present disclosure is a multistep process comprising adding certain ingredients, mixing them under shear, and repeating until all ingredients are incorporated. In some embodiments the foodstuff can be mixed with a Lightnin Mixer, available from LIGHTNIN, Rochester, N.Y. A medium shear mixing can be used for the process steps, however, a high shear mixer can optionally be used for incorporating coconut ingredient in order to make small fat droplets. Ingredients of the present disclosure should not exceed a temperature above 40° F. prior to batching. In some embodiments, ingredients can be pre-mixed together prior to batching. The process may take place in any one or more vessels appropriate for heating and mixing food ingredients. In some embodiments, the vessel in which the ingredients of the present foodstuff are processed is a batch tank. In one embodiment, the vessels in which the ingredients of the foodstuff are processed is a cook kettle connected to a liquefier. In another embodiment, the mixture can be recirculated between the cook kettle and liquefier for purposes of mixing, or flushing pipelines connecting the vessels.

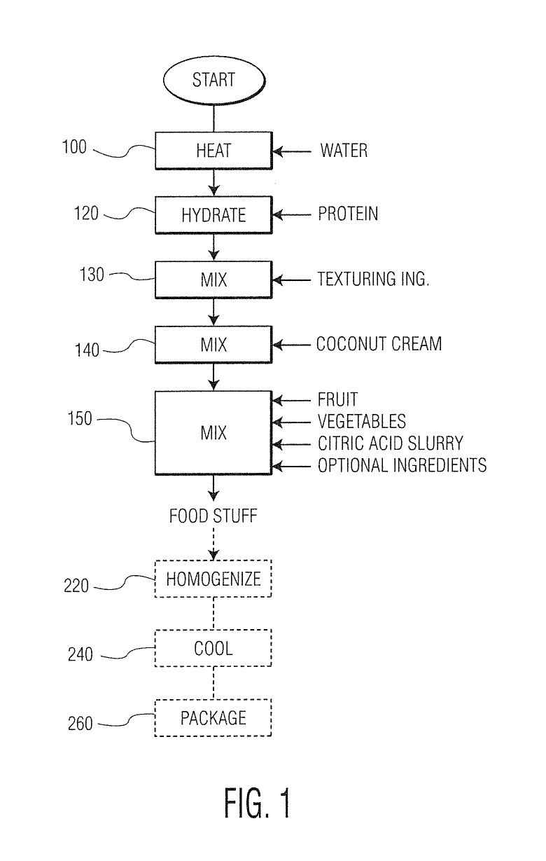

An exemplary process is illustrated in the flowchart of FIG. 1, and begins at Step 120 by adding water to a vessel (e.g., a batch tank or cook kettle), and heating the water to 160° F. (+/−5° F.). Protein, such as pea protein and chia seed flour, can also be added to the heated water at Step 120 and hydrated for about 2 minutes under shear to form a first mix. The hydration of the solid protein ingredients softens them to a state that allows efficient incorporation into the mixture with subsequent ingredients.

A first set of texturing ingredients, such as pectins, locust bean gum and tapioca can be added at Step 130 and mixed into the first mix in the vessel for about 5 minutes, to form a second mix.

In some embodiments, the coconut fat can be heated until it is in a liquid state (to about 110° F.) and thoroughly mixed under shear to form a creamed coconut ingredient prior to being introduced into the second mix at Step 140. In one embodiment, the coconut ingredient can be processed in a first vessel, such as a cook kettle as the second mix can be processed in a second vessel, such as a liquefier. In some embodiments, heated coconut ingredient and glycerin can be added to the second mix at Step 140 and mixed for about 5 minutes to form a third mix. In certain embodiments using a cook kettle connected to a liquefier, the mixing can be done by recirculating the ingredients between the cook kettle and liquefier with the agitators in operation.

Fruit and/or vegetable ingredients in the form of puree, juice, semi-solids, or combinations thereof, and a citric acid ingredient can be added to the third mix at Step 150 to form a final mix and mixed for about 10 minutes to form a foodstuff of the invention. Optionally, coloring and various other optional ingredients (e.g., stabilizers, fortifiers and the like) can be added along with the flavorings and citric acid when they are added to the third mix at Step 150.

Although not shown in FIG. 1, optionally, the pH and Brix of the final mixture can be measured and adjusted as necessary to achieve any desired target, using means known to the art. In some embodiments using high acid ingredients, such as lemon or lime, the pH can be below 4.6, and then the food can be classified as an acid food. In embodiments wherein the pH is above 4.6, acid ingredients can be added to produce a final pH of 4.6 or below, and the foodstuff can be classified as an acidified food. In certain embodiments of the invention using high acid ingredients, the foodstuff may not be below pH 4.6, but may require less acid ingredients to adjust the pH downward than for foodstuffs of the invention which do not use high acid ingredients.

pH of an acid or acidified food is typically reported as the “equilibrium pH,” which can be defined as the overall pH of the uniformly mixed ingredients of the foodstuff. Any suitable method and apparatus for measuring equilibrium pH can be used to determine the pH of the present foodstuffs, as are well-known to those of ordinary skill in the art. For example, any research- or commercial grade pH meter (for example with an integral or detachable electrode) that offers resolution and accuracy of 0.1 pH units or better can be used. Different techniques to determine equilibrium pH can be used, depending on the nature and consistency of the foodstuff. For example, in embodiments of the invention wherein the foodstuff is homogeneous, that is, of uniform consistency, the pH of any portion can be considered to be representative of the whole and thus no special preparation is required to measure the equilibrium pH for this type of foodstuff. In embodiments of the invention wherein the foodstuff is semi-solid, the foodstuff can be blended to a uniform paste before measuring the equilibrium pH. If additional liquid is required to blend samples for measuring equilibrium pH, up to 20 parts deionized or distilled water may be added, for example, per 100 parts of foodstuff. In certain embodiments, the equilibrium pH measured is the “maximum” or “final” equilibrium pH of the finished product after acidification to the nearest tenth of a pH unit, for example as measured within 24 hours after processing.

If equilibrium pH is to be measured in finished or unfinished foodstuffs of the invention which are a mixture of solids and liquid, the equilibrium pH can be determined, for example, by separating the liquid and solid components by draining the contents of the foodstuff for two minutes on a U.S. standard No. 8 sieve, inclined at a 17 to 20 degree angle. Each portion can be saved separately, and the weight of both the liquids and the solids recorded. The drained solids can be rinsed with deionized or distilled water to remove any remaining covering liquid, and blended to a uniform paste. If additional liquid is required to blend the solid portion, up to 20 parts deionized or distilled water can be added, for example per 100 parts foodstuff. To determine the “equilibrium pH” of the foodstuff, of both solid and liquid portions can be blended in the same ratio as found in the original container, and the pH of the combined portion measured. In some embodiments, the equilibrium pH of the present foodstuffs can be adjusted as needed with the amount of citric acid in the citric acid ingredient. In other embodiments, the foodstuff of the invention can be adjusted to an optimum pH (e.g., about 4.6, or about 4.6 and below) to minimize bacterial or other pathogen growth, for example according to the acidified food regulations described in the Code of Federal Regulations Title 21 Part 114 for FDA regulated products or Title 9 Parts 318 and 381 for USDA regulated products, or comparable regulations in other jurisdictions (e.g., Canada).

The foodstuffs of the invention can have any equilibrium pH which allows for or produces, for example, any desirable characteristic or characteristics, such as shelf- or storage-stability, a target consistency or mouthfeel, or reduction or inhibition in pathogen growth (for example of heat-resistant pathogens such as Clostridium botulinum). One or more such desirable characteristics can be achieved in the present foodstuffs using an equilibrium pH of about 4.6 or below. In some embodiments, the equilibrium pH of the foodstuff can be adjusted to a range of about 3.5-4.6, for example to about 3.9 or about 4.0.

In certain embodiments, the foodstuffs of the invention can be homogenized at optional Step 220. In some embodiments a two stage homogenizer can be used. The stage two pressure can be about 1500 psi, and the stage one pressure can be about 10% of the stage two pressure. In some embodiments, the foodstuff is heated to about 160-165° F. prior to homogenization. Failure to follow the process outlined above may result in a runny and gritty formula that may not be safe for consumption at room temperature. For example, if ingredients are not batched correctly or heated to the appropriate temperatures, the product may not achieve the desirable texture, mouthfeel or may lack other qualities which could make it unpleasant or less desirable to consume, or which may affect packaging, storage or the like.

In some embodiments the foodstuff can be pasteurized (e.g., cooked) in a process designed, for example, to destroy or inhibit the growth of pathogens such as yeasts, molds and vegetative cells of bacteria. and make the foodstuff shelf stable at optional Step 240. The time and temperature parameters for pasteurization can be, for example, according to FDA guidelines and/or designed to produce a desired reduction in one or more target pathogens (e.g., Escherichia coli O157:H7, Salmonella enterica or Listeria monocytogenes), for example to attain an about 7- to 10-log reduction in a target pathogen In one embodiment the foodstuff can be heated to 140° F. for 30 minutes. In another embodiment the foodstuff can be heated to 155° F. for 15 minutes. In another embodiment the foodstuff may be flash pasteurized by heating to 185° F. for 4 seconds.

In another embodiment, a foodstuff of the invention having a final equilibrium pH of about 3.9 can be processed to a minimum temperature of about 181° F. with a hold time of at least about 1.6 minutes. This time can be attained, for example, on product processing lines with a maximum flow rate of about 16 l/min, a minimum temperature of about 181° F. with a hold time of about 1.67 minutes and a maximum flow rate of about 24 l/min, or a minimum temperature of about 184° F. with a hold time of about 1.1 minutes and a maximum flow rate of about 36 l/min. These processing parameters can, for example, provide a Least Sterilizing Value (LSV) of about 0.1 minutes, using a z=16 and a reference temperature of 200° F. If the foodstuff is to be filled into a closed container, the container can be held in an environment that will enable the product to remain, for example, at a minimum temperature of about 180° F. for at least about 3 minutes. If the foodstuff is to be sent through a post process pasteurizer, the container can be filled at a minimum temperature of about 180° F. and then held for at least about 3 minutes in the pasteurizer at a minimum temperature of about 180° F.

In another embodiment, a foodstuff of the invention having a final equilibrium pH of about 4.0 can The product will need to be processed to a minimum temperature of about 192° F. with a hold time of at least about 1.6 minutes. This time can be attained, for example, on product processing lines with a maximum flow rate of about 16 l/min, a minimum temperature of about 192° F. with a hold time of about 1.67 minutes and a maximum flow rate of about 24 l/min, or a minimum temperature of about 195° F. with a hold time of about 1.1 minutes and a maximum flow rate of about 36 l/min. These processing parameters can, for example, provide a Least Sterilizing Value (LSV) of about 0.5 minutes, using a z=16 and a reference temperature of 200° F. If the foodstuff is to be filled into a closed container, the container can be held in an environment that will enable the product to remain, for example, at a minimum temperature of about 185° F. for at least about 3 minutes. If the foodstuff is to be sent through a post process pasteurizer, the container can be filled at a minimum temperature of about 185° F. and then held for at least about 3 minutes in the pasteurizer at a minimum temperature of about 185° F.

Additional optional steps may include cooling the foodstuff using means known in the art, such as a scraper-surface heat-exchanger.

Also, the foodstuff can be packaged; see, e.g., optional Step 260 in FIG. 1. Any suitable packaging as is known in the art can be used, such as poly tube packaging. Packaging can be an opaque material (for example, in the container closure or as one or more layers) to protect the foodstuff from the impacts of artificial and/or natural light, or which contain oxygen scavenging materials. In some embodiments a 48G PET/Adhesive/200G White EVOH poly tube packing material can be used.

The foodstuff can be filled hot into packaging and sealed securely to block air from flowing in (high barrier properties). In some embodiments the foodstuff will be heated to 140-190° F. prior to packaging. The tube packages can be transferred to a cooling bath after filling (for example, to lower the temperature of the foodstuff (e.g., to 90° F. or below.)

A vertical form, fill, and seal machine that is capable of filling the foodstuff at a hot temperature can be used in some embodiments. For example, a film roll stock may feed two sheets through a filling machine (e.g., one sheet forming the front and one sheet forming the back of the container). The film roll stock can be vertically cut and heat-sealed at the same time to form a tube. Optionally, the machine can support a horizontal tear vs. the vertical tear that is typical for this type of machine. A horizontal tear can be easier to tear open the package, and reduces spilling that can occur with vertical tear packaging. Additionally, a horizontal tear can prevent a potential choking hazard in comparison to a vertical tear that is not torn off completely. The horizontal tear can be formed, for example, by a horizontal heat-seal crimping and cutting the film, and separating the top of one tube from the bottom of another. During this process, the foodstuff formulations of the invention can fill the tube to the desired weight. The horizontal heat-seal may then come across separating again the top of one tube from the bottom of another.

The following non-limiting examples further illustrate different embodiments of the composition of the non-dairy yogurt alternative foodstuff. Nevertheless, it will be understood that various modifications can be made without departing from the spirit and scope of the invention. For all examples herein, SS stands for single strength, and the flavor ingredients are identified by vendor's codes, to ensure the correct flavor is being used.

### Example 1

In this example, an organic strawberry-flavored non-dairy yogurt formulation was produced according to the process shown in FIG. 1, using the ingredients listed in Table 1.

TABLE 1
Example formulation for organic strawberry-flavored non-dairy
yogurt alternative foodstuff

| Ingredient | Weight | Unit of Weight | Percentage |
|---|---|---|---|
| Water | 83.68 | Lbs. | 37.96% |
| Organic Strawberry Puree, Single | 39.68 | Lbs. | 18.00% |
| Strength (SS) | | | |
| Organic Sweet Potato Puree, SS | 35.27 | Lbs. | 16.00% |
| Organic Pear Juice Concentrate 70 | 23.58 | Lbs. | 10.70% |
| Brix | | | |
| Organic Creamed Coconut | 11.02 | Lbs. | 5.00% |
| Glycerin | 6.61 | Lbs. | 3.00% |
| Organic Banana Puree, SS | 4.40 | Lbs. | 2.00% |
| Pea Protein | 4.30 | Lbs. | 1.95% |
| Organic Tapioca Starch | 3.30 | Lbs. | 1.50% |
| Organic Carrot Puree | 2.20 | Lbs. | 1.00% |
| Pectin LM 104 AS | 1.76 | Lbs. | 0.80% |
| Strawberry Flavor FY5193 | 1.32 | Lbs. | 0.60% |
| Summer Shade Red | 0.88 | Lbs. | 0.40% |
| Citric Acid | 0.66 | Lbs. | 0.30% |
| Organic Red Beet Juice | 0.55 | Lbs. | 0.25% |
| Concentrate | | | |
| Organic Chia Seeds Flour | 0.44 | Lbs. | 0.20% |
| Pectin CP Kelco Beta | 0.22 | Lbs. | 0.10% |
| Juicy Flavor NV61765 | 0.22 | Lbs. | 0.10% |
| Monkfruit Extract | 0.08 | Lbs. | 0.04% |
| Locust Bean Gum | 0.22 | Lbs. | 0.10% |

Water (44.45 lbs.) was added to a batch tank and heated to 160° F. (+/−5° F.). Pea protein and chia seed flour in the quantities listed in Table 1 were added to the heated water in the batch tank and hydrated for 20 minutes under shear to form a first mix.

A combination of texturing ingredients (pectins, locust bean gum and tapioca starch) were added to the batch tank at the quantities listed in Table 1 along with 26.45 lbs. of water, and mixed into the first mix in the batch tank for 5 minutes, to form a second mix.

Coconut fat (11.02 lbs.) was heated until it was in a liquid state (to about 110° F.-120° F.) and thoroughly mixed under shear to form a creamy coconut paste prior to being introduced to the batch tank. The heated creamy coconut paste, glycerin, and 6.61 lbs. of water are added to the second mix and mixed for 5 minutes to form a third mix.

A citric acid slurry was formed by combining 0.66 lbs. of citric acid, 0.66 lbs. of water, and 0.08 lbs. of monkfruit extract, and mixed until the citric acid was dissolved

The fruit ingredient and vegetable ingredient, along with the citric acid slurry, summer shade red 843301 coloring, natural strawberry flavor FY5193, natural juicy flavor NV61765 (as listed in Table 1) were added to the third mix to form a final mix and mixed for about 10 minutes to form a foodstuff. The foodstuff was found to have a pleasing strawberry flavor, and texture and mouth feel similar to yogurt.

### Example 2

In this example, a tropical berry-flavored non-dairy yogurt formulation was produced according to the process shown in FIG. 1, using the ingredients listed in Table 2.

TABLE 2
Example formulation for tropical berry-flavored non-dairy
yogurt alternative foodstuff

| Ingredient | Weight | Unit of Weight | Percentage |
|---|---|---|---|
| Water | 99.99 | Lbs. | 48.71% |
| Pineapple Juice Concentrate 65 | 21.45 | Lbs. | 9.73% |
| Brix | | | |
| Organic Sweet Potato Puree, SS | 26.45 | Lbs. | 12.00% |
| Organic Orange Juice Concentrate | 4.96 | Lbs. | 2.25% |
| Organic Creamed Coconut | 11.02 | Lbs. | 5.00% |
| Glycerin | 6.61 | Lbs. | 3.00% |
| Organic Banana Puree, SS | 11.02 | Lbs. | 5.00% |
| Pea Protein | 4.48 | Lbs. | 2.03% |
| Organic Tapioca Starch | 3.31 | Lbs. | 1.50% |
| Organic Butternut Squash Puree | 18.74 | Lbs. | 8.50% |
| Pectin LM 104 AS | 1.76 | Lbs. | 0.80% |
| Pineapple Flavor NV90085 | 0.44 | Lbs. | 0.20% |
| Orange Sunrise | 0.44 | Lbs. | 0.20% |
| Citric Acid | 0.77 | Lbs. | 0.35% |
| Organic Chia Seeds Flour | 0.44 | Lbs. | 0.20% |
| Pectin CP Kelco Beta | 0.22 | Lbs. | 0.10% |
| Peach Flavor NV90201 | 0.66 | Lbs. | 0.30% |
| Monkfruit Extract | 0.06 | Lbs. | 0.03% |
| Locust Bean Gum | 0.22 | Lbs. | 0.10% |

Water (68.03 lbs.) was added to a batch tank and heated to 160° F. (+/−5° F.). Pea protein and chia seed flour in the quantities listed in Table 2, were added to the heated water in the batch tank and hydrated for 20 minutes under shear to form a first mix.

A combination of texturing ingredients (pectins, locust bean gum and tapioca starch) were added to the batch tank at the quantities listed in Table 2 along with 26.45 lbs. of water, and mixed into the first mix in the batch tank for 5 minutes, to form a second mix.

Coconut fat (11.02 lbs.) was heated until it was in a liquid state (to about 110° F.) and thoroughly mixed to form a creamy coconut paste prior to being introduced to the batch tank. The heated creamy coconut paste, glycerin, and 6.61 lbs. of water were added to the second mix and mixed for 5 minutes to form a third mix.

A citric acid slurry was formed by combining 0.77 lbs. of citric acid, 0.77 lbs. of water, and 0.066 lbs. of monkfruit extract, and mixed until the citric acid was dissolved.

The fruit ingredient and vegetable ingredient, along with the citric acid slurry, orange sunrise coloring, pineapple flavor NV90085, and peach flavor NV90201 (in quantities as listed in Table 2) were added to the third mix to form a final mix and mixed for about 10 minutes to form a foodstuff. The foodstuff was found to have a pleasing tropical berry flavor, and a texture and mouth feel similar to yogurt.

### Example 3

In this example, a mixed berry-flavored non-dairy yogurt formulation was produced according to the process shown in FIG. 1, using the ingredients listed in Table 3.

TABLE 3
Example formulation for mixed berry-flavored non-dairy
yogurt alternative foodstuff

| Ingredient | Weight | Unit of Weight | Percentage |
|---|---|---|---|
| Water | 84.68 | Lbs. | 43.91% |
| Organic Pear Juice Concentrate 70 | 9.25 | Lbs. | 4.20% |
| Brix | | | |
| Organic Sweet Potato Puree, SS | 17.63 | Lbs. | 8.00% |
| Organic White Grape Juice | 11.97 | Lbs. | 5.43% |
| Concentrate 65 Brix | | | |
| Organic Creamed coconut | 11.02 | Lbs. | 5.00% |
| Glycerin | 6.61 | Lbs. | 3.00% |
| Organic Banana Puree, SS | 8.81 | Lbs. | 4.00% |
| Pea Protein | 4.89 | Lbs. | 2.22% |
| Organic Tapioca Starch | 3.30 | Lbs. | 1.50% |
| Organic Strawberry Puree | 17.63 | Lbs. | 8.00% |
| Pectin LM 104 AS | 1.76 | Lbs. | 0.80% |
| Mixed Berry Flavor FY4895 | 1.10 | Lbs. | 0.50% |
| Shade Cherry Red | 0.66 | Lbs. | 0.30% |
| Citric Acid | 0.66 | Lbs. | 0.30% |
| Organic Beet Puree | 0.66 | Lbs. | 0.30% |
| Organic Chia Seeds Flour | 0.44 | Lbs. | 0.20% |
| Pectin CP Kelco Beta | 0.22 | Lbs. | 0.10% |
| Juicy Flavor NV90193 | 0.22 | Lbs. | 0.10% |
| Monkfruit Extract | 0.07 | Lbs. | 0.035% |
| Locust Bean Gum | 0.22 | Lbs. | 0.10% |
| Raspberry Puree, Seedless | 17.63 | Lbs. | 8.00% |
| Organic Blueberry Puree SS | 8.81 | Lbs. | 4.00% |

Water (57.57 lbs.) was added to a batch tank and heated to 160° F. (+1-5° F.). Pea protein and Chia seed flour in the quantities listed in Table 3, were added to the heated water in the batch tank and hydrated for 20 minutes under shear to form a first mix.

A combination of texturing ingredients (pectins, locust bean gum and tapioca starch) were added to the batch tank at the quantities listed in Table 3 along with 26.45 lbs. of water, and mixed into the first mix in the batch tank for 5 minutes, to form a second mix.

2. Coconut fat (88 lbs.) was heated until it was in a liquid state (to about 110° F.) and thoroughly mixed to form a creamy coconut paste prior to being introduced to the batch tank. The creamy coconut paste, glycerin and 5.51 lbs. of water were added to the second mix and mixed for 5 minutes to form a third mix.

A citric acid slurry was formed by combining 0.66 lbs. of citric acid, 0.66 lbs. of water, and 0.077 lbs. of monkfruit extract, and mixed until the citric acid was dissolved.

The fruit ingredient and vegetable ingredient, along with the citric acid slurry, shade cherry red coloring, mixed berry flavor FY4895, juicy flavor NV90193 (in quantities as listed in Table 3) were added to the third mix to form a final mix and mixed for about 10 minutes to form a foodstuff. The foodstuff was found to have a pleasing mixed berry flavor, and a texture and mouth feel similar to yogurt.

### Example 4

In this example, a strawberry-flavored non-dairy yogurt formulation was produced according to the process shown in FIG. 1, using the ingredients listed in Table 4.

TABLE 4
Example formulation for strawberry-flavored non-dairy
yogurt alternative foodstuff

| Ingredient | Weight | Unit of Weight | Percentage |
|---|---|---|---|
| Water | 629.7 | Lbs. | 35.780% |
| Organic Strawberry Puree, SS | 316.8 | Lbs. | 18.000% |
| Organic Sweet Potato Puree, SS | 281.6 | Lbs. | 16.000% |
| Organic Pear Juice Concentrate | 227.9 | Lbs. | 12.950% |
| Organic Creamed Coconut | 88.0 | Lbs. | 5.000% |
| Glycerin | 52.8 | Lbs. | 3.000% |
| Organic Banana Puree, SS | 35.2 | Lbs. | 2.000% |
| Pea Protein | 33.44 | Lbs. | 1.900% |
| Organic Tapioca Starch | 26.4 | Lbs. | 1.500% |
| Organic Carrot Puree | 17.6 | Lbs. | 1.000% |
| Pectin LM 104 AS | 14.1 | Lbs. | 0.800% |
| Strawberry Flavor | 10.6 | Lbs. | 0.600% |
| Summer Shade Red | 7.0 | Lbs. | 0.400% |
| Citric Acid | 5.3 | Lbs. | 0.300% |
| Organic Red Beet Juice | 4.4 | Lbs. | 0.250% |
| Concentrate | | | |
| Organic Chia Seeds Flour | 3.52 | Lbs. | 0.200% |
| Pectin CP Kelco Beta | 1.76 | Lbs. | 0.100% |
| Juicy Flavor NV-90,193 | 1.76 | Lbs. | 0.100% |
| Monk Fruit Extract | 0.35 | Lbs. | 0.020% |
| Locust Bean Gum | 1.76 | Lbs. | 0.100% |

Water (491.2 lbs.) was added to a cook kettle, heated to 160° F., and then pumped to a liquefier. Pea protein and Chia seed flour in the quantities listed in Table 4, were added to the heated water in the liquefier, with agitation on, and hydrated for 2 minutes to form a first mix.

The pectins (at the quantities listed in Table 4) were added to the liquefier and mixed for 2 minutes. The locust bean gum and tapioca starch were added to the liquefier at the quantities listed in Table 4 and mixed for 1 minute. The glycerin was added to the liquefier and mixed for 5 minutes, to form a second mix.

Organic Creamed Coconut (88 lbs.) was heated in a cook kettle until it was completely melted. The second mix was pumped out of the liquefier on top of the melted Organic Creamed Coconut. The contents of the cook kettle were then recirculated from the cook kettle to the liquefier (with agitation on both the liquefier and the cook kettle) to thoroughly blend all ingredients, to form a third mix. The third mix was pumped to the cook kettle. The fruit ingredient and vegetable ingredient, (in quantities as listed in Table 4) were added to the third mix.

In the liquefier, 94.46 lbs. of cold water was agitated with 5.28 lbs. of citric acid, and 159.67 grams of monkfruit extract for 1-2 minutes (until the citric acid was dissolved), to form a citric acid slurry. The citric acid slurry was pumped to the cook kettle. In the liquefier, 44.1 lbs. of hot water were added, then pumped to cook kettle to flush the equipment. The cook kettle was heated to 150° F., and summer shade red, strawberry flavor, and juicy flavor were added, to form a final mixture. The final mixture was heated to 160° F. and then it was pumped to a hold kettle through a homogenizer at 1500 psi, to form the foodstuff. The foodstuff was pumped through a heat exchanger to a packaging system and packaged into tube packages.

While the present disclosure has been discussed in terms of certain embodiments, it should be appreciated that the present disclosure is not so limited. The embodiments are explained herein by way of example, and there are numerous modifications, variations and other embodiments that can be employed that would still be within the scope of the present invention.

1. A process for making a non-dairy foodstuff, the process comprising:
a) adding a protein ingredient to heated water in a vessel to create a first mix;
b) hydrating the first mix under shear;
c) adding a texturing ingredient to the first mix in the vessel and mixing to form a second mix;
d) adding coconut ingredient to the second mix and mixing to form a third mix;
e) adding at least one of a fruit ingredient or a vegetable ingredient, or a combination thereof, each in the form selected from puree, juice, semi-solids, and combinations thereof, and citric acid ingredient and mixing to form a final mix; and
f) mixing the final mix until all ingredients are fully incorporated to form the non-dairy foodstuff, wherein the non-dairy foodstuff has a texture and mouth feel substantially similar to yogurt.

2. The process of claim 1, further comprising:
adding at least one of coloring ingredient or flavoring ingredient to the final mix of step e).

3. The process of claim 2, further comprising:
homogenizing the foodstuff;
pasteurizing the foodstuff; and
packaging the foodstuff into one or more poly tubes.

4. The process of claim 3, further comprising:
cooling the foodstuff.

5. The process of claim 1 wherein the vessel is a batch tank.

6. The process of claim 1 wherein the vessel is a cook kettle connected to a liquefier, and at least some of the mixing is performed by recirculating said mixes between the cook kettle and the liquefier.

7. The process of claim 1 wherein the protein ingredient is a gluten-free and soy-free vegetable protein.

8. The process of claim 7 wherein the protein ingredient is selected from chia seeds flour, pea protein, and a combination thereof.

9. The process of claim 1 wherein the fruit ingredient is selected from strawberry, pear, banana, blueberry, blackberry, pineapple, apple, apricot, coconut, grape, lemon, lime, melon, orange, peach, raspberry, acai, mango, passion fruit, papaya, plum and any combinations thereof.

10. The process of claim 1 wherein the vegetable ingredient is selected from sweet potato, red beet, potato, carrot, squash, tomato, celery, pumpkin, kale, mustard, Swiss chard, spinach, broccoli, cauliflower, peas, beans, garlic, onion, radish, seaweed, and any combinations thereof.

11. The process of claim 2 wherein the flavoring ingredient is any natural or artificial flavoring.

12. The process of claim 11 wherein the natural or artificial flavoring is selected from fruit, vegetable, chocolate, spice, herb, vanilla and any combinations thereof.

13. The process of claim 1 wherein the citric acid ingredient is selected from a dry form, solution, or slurry.

14. The process of claim 13 wherein the citric acid slurry is a combination of citric acid, water and monkfruit extract that is mixed until the citric acid is dissolved.

15. The process of claim 1 wherein the texturing ingredient is selected from pectins, gums, tapioca, and combinations thereof.

16. The process of claim 1 wherein glycerin is added along with coconut ingredient to the second mix in step d).

17. The process of claim 1 wherein the coconut ingredient is creamy coconut paste.

18. The process of claim 17 wherein the creamy coconut paste is formed by heating coconut fat until it is in a liquid state and mixing it under shear until it is creamy.

19. A formulation for a non-dairy foodstuff comprising:
a) 20-70 wt. % at least one of a fruit ingredient, or a vegetable ingredient, or a combination thereof;
b) 1-4 wt. % protein ingredient;
c) 2-8 wt. % coconut ingredient;
d) 2-8 wt. % texturing ingredient; and
e) 20-60 wt. % water.

20. The formulation of claim 19 further comprising 0.5-4 wt. % of flavoring ingredient, wherein the flavoring ingredient is any natural or artificial flavoring ingredient selected from fruit, vegetable, chocolate, spice, herb, vanilla and any combinations thereof.

21. The formulation of claim 19 further comprising up to 4 wt. % of an ingredient selected from colorings, stabilizers, fortifiers, and any combinations thereof.

22. The formulation of claim 19 wherein the fruit ingredient is selected from strawberry, pear, banana, blueberry, blackberry, pineapple, apple, apricot, coconut, grape, lemon, lime, melon, orange, peach, raspberry, acai, mango, passion fruit, papaya, plum and any combinations thereof.

23. The formulation of claim 19 wherein the vegetable ingredient is selected from sweet potato, red beet, potato, carrot, squash, tomato, celery, pumpkin, kale, mustard, Swiss chard, spinach, broccoli, cauliflower, peas, beans, garlic, onion, radish, seaweed, and any combinations thereof.

24. The formulation of claim 19 wherein the protein ingredient is a gluten-free and soy-free vegetable protein, selected from chia seeds flour, pea protein, and a combination thereof.

25. The formulation of claim 19 wherein the texturing ingredient is selected from a pectin, gum, tapioca, glycerin, and any combination thereof.

26. The formulation of claim 25 wherein the gum is locust bean gum.

27. The formulation of claim 19 wherein the formulation has an equilibrium pH in the range of about 3.5-4.6.

28. A non-dairy foodstuff prepared by a process comprising the steps of:
a) providing the formulation of claim 19;
b) mixing said formulation to form a foodstuff;
c) homogenizing the foodstuff; and
d) pasteurizing the foodstuff.

29. The non-dairy foodstuff of claim 27 further comprising packaging the foodstuff.
